(19) United States
(12) Patent Application Publication
(10) Pub. No.: US 2026/0310254 A1
(43) Pub. Date: Oct. 8, 2026

(54) Hardware Mechanism for Universal Synchronization of Communications in an SOC

(71) Applicant: Google LLC, Mountain View, CA (US)

(72) Inventors: Seyed Hossein Sadat Kooch Mohtasha, San Diego, CA (US); Amit Jindal, San Jose, CA (US); Mark Woh, San Bruno, CA (US); Gopi Krishna Tummala, San Jose, CA (US)

(73) Assignee: Google LLC, Mountain View, CA (US)

(21) Appl. No.: 19/483,926

(22) PCT Filed: May 24, 2023
(86) PCT No.: PCT/US2023/023392

§ 371 Date: Nov. 12, 2025

(51) Int. Cl. G06F 1/12

(52) U.S. Cl. CPC G06F 1/12

(57) ABSTRACT

Methods and systems, including computer-readable media, are described for implementing a hardware synchronization unit at an integrated circuit, such as a system-on-chip (“SoC”) of a mobile device. The synchronization unit is configured to generate a global sync object that is used to control and manage one or more synchronization events at the SoC. The synchronization unit determines context states with reference to the global sync object. Each of the context states correspond to a respective IP device among multiple IP devices on the SoC. The synchronization unit generates register values that represent each of the context states and manages execution of synchronization events based on the global sync object and the register values. The synchronization events involve each IP device and are executed concurrent with a heterogeneous compute performed at the SoC using the IP devices.

### BACKGROUND

This specification generally relates to a mechanism for universally synchronizing communications between IP blocks of a system-on-chip (“SoC”).

Modern computing systems usually incorporate a wide variety of compute processing units that each offer different computing capabilities and trade-offs. Efficient execution of a given compute job often involves parsing computations into meaningful sub-tasks or workloads that are mapped to available processor cores of a computing system. The computations may be parsed and mapped based on suitability criteria, such as processor capability, performance, and power. Generally, this overall process of allocating portions of a compute to appropriate processor resources is referred to as heterogeneous compute.

At least one processor core of the computing system can be an Intellectual Property block (“IP block”) that executes a respective portion of a computational operation for different multimedia use cases. An example use case can involve processing image data captured by a camera of the mobile device. Using heterogeneous compute to process the image data requires synchronization among processor cores that receive respective allocations of sub-tasks. The resource overhead required to implement this synchronization is usually significant relative to the computation work. This resource requirement introduces bubbles that delay or degrade operations in the data processing pipeline.

### SUMMARY

This specification describes a hardware mechanism that is used to universally synchronize communications between IP blocks (or devices) of a system-on-chip (“SoC”). The hardware mechanism can be an example sync module that is implemented as a discrete processor, as a floating role migrating compute element, or both. For example, the hardware mechanism can be used to synchronize a subset of communications at the SoC based on sync objects that are passed between the IP devices and register values that represent context states of the IP devices.

The sync module can include, or even represent, a hardware synchronization unit with various processor resources for implementing universal IP synchronization, including one-to-many and many-to-many synchronization between IP devices of the SoC. The resources of the hardware synchronization unit include control logic and memory for generating, tracking, and managing objects or data values corresponding to synchronization events executed at the SoC. More specifically, the memory can include static random-access memory (“SRAM”) circuitry as well as control and status registers (“CSRs”).

The hardware synchronization unit is configured to generate a global sync object that is used to control and manage one or more synchronization events of a heterogeneous compute executed at the SoC. The hardware synchronization unit can generate the global sync object in response to receiving a request from an IP device of the SoC. For example, the global sync object may be generated based on a request from an application (e.g., a camera) that generates data for processing by multiple IP devices of the SoC. Each IP device can be a processor (or processor core) of an IP block on the SoC.

To process the data, the SoC initiates a heterogeneous compute operation where each of the multiple IP devices are responsible for a specific compute of the heterogeneous operation. For example, the data can be image data and the heterogeneous compute can include: i) an inference operation to perform facial recognition on the image data and ii) a scaling operation to perform post-processing on the image data. The heterogeneous compute involves some (or all) of the multiple IP devices on the SoC and requires synchronization of certain compute steps amongst the IP devices.

The sync module configures the global sync object as a first class object such that the hardware synchronization unit can implement the required synchronization in a manner that is universal to each IP device of the SoC. The hardware synchronization unit uses the global sync object to control and manage synchronization events that facilitate execution of the heterogeneous compute at the SoC. The hardware synchronization unit determines context states with reference to the global sync object. At least one context state corresponds to a respective IP device on the SoC and the hardware synchronization unit uses its CSRs to store values that indicate context states for each of the IP devices.

As the heterogeneous compute is executed, the hardware synchronization unit generates and iteratively updates register values for each of the context states and manages execution of the synchronization events based on the global sync object and these register values.

One aspect of the subject matter described in this specification can be embodied in a computer-implemented method performed at a system-on-chip (“SoC”) of a user device using a hardware sync unit of the SoC. The method includes: generating, by the hardware sync unit, a global sync object that is used to control and manage one or more synchronization events at the SoC. The hardware sync unit determines context states with reference to the global sync object. Each of the context states correspond to a respective IP device among multiple IP devices on the SoC. The method includes: generating, at the hardware sync unit, multiple register values that represent each of the context states corresponding to each respective IP device; and managing, by the hardware sync unit, an execution of synchronization events involving each of the IP devices based on the global sync object and the register values.

These and other implementations can each optionally include one or more of the following features. For example, in some implementations, generating the global sync object includes: receiving, by the hardware sync unit, a global sync request from a first IP device; and generating, by the hardware sync unit, the global sync object based on the global sync request from a first IP device. Generating the global sync object includes: generating, by the hardware sync unit, control signaling that initiates execution of the synchronization events at the SoC. The control signaling can include a first sync control signal that passes the global sync object to the first IP device.

In some implementations, the method further includes: detecting, by the hardware sync unit, secondary global sync objects that are generated based on the control signaling that initiates execution of the synchronization events at the SoC. Each of the secondary global sync objects corresponds to a universal/global sync ID that is propagated to a respective IP device of the multiple IP devices. One or more of the secondary global sync objects can be: passed between at least two of the multiple IP devices to execute one or more of the synchronization events; and used to execute respective synchronization events for distinct data processing operations that are performed concurrently to process event data associated with an application executed at the user device.

In some implementations, the method further includes: synchronizing, using the hardware sync unit, a subset of communications at the SoC based on the global sync object and each of the register values that represent each of the context states at the hardware sync unit. The method can further include: associating, using the global sync object, each of the context states with a respective IP device among the multiple IP devices and synchronization activity corresponding to that IP device.

For each of the multiple IP devices, the synchronization activity can include: i) a first sync event representing a signal event; and ii) a second, different sync event representing a wait event. The method can further include: detecting, at the SoC, a request to process event data associated with an application executed at the user device. In some implementations, the synchronization events are executed at the SoC concurrent with data processing operations of each IP device that is used to process the event data.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages.

The disclosed techniques provide a hardware synchronization mechanism that is universal across multiple (or all) IP devices in an example computing system. The universal aspect of the mechanism enables one IP device to signal an event or computational task to multiple IP devices at the same time (e.g., concurrently). For example, a first processor that generates image data can use the hardware synchronization unit to concurrently signal: i) a second processor that applies a machine-learning (ML) algorithm to the image data and ii) a third processor that performs digital signal processing on the image data.

The hardware synchronization mechanism is associated with a sync module that can generate a global sync object and implement that global sync as a first-class object. For example, the global sync object is configured with native identity that supports certain sync operations natively, without requiring an application processor (AP) be integrated at an IP device to decipher or process synchronization instructions/commands. Thus, the global sync object is not required to be coded or defined in a particular programming language, which simplifies the design effort and minimizes the resource overhead required to implement the hardware synchronization unit at an integrated circuit.

Relatedly, the hardware synchronization mechanism provides universal/shared synchronization semantics that can be used and leveraged by a variety of IP devices on a SoC. The hardware synchronization mechanism can interact with a source IP device to convey meaning to a particular synchronization object. The hardware synchronization mechanism can generate multiple synchronization objects that each have global identity such that the sync object can be used by a source IP device to signal events to multiple other IP devices. The global identity of the sync object is achieved based on the global representation maintained by the proposed hardware mechanism.

For example, the hardware synchronization mechanism can include control logic used to establish a parameter/data value, e.g., the integer “10,” as a sync_ID. This sync_ID can be a global identifier for a sync object (or global sync object) such that the parameter value of “10” indicates the same sync object on different IP devices or running processors of a SoC. The hardware synchronization mechanism can ensure that all processors in the system recognize “10” as the same/global identity for a given sync object that is identified by that data value.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system with at least one SoC.

FIG. 2A shows an example hardware synchronization unit.

FIG. 2B shows example code for generating a global sync object.

FIG. 3 is a block diagram showing an example routing of synchronization signaling among IP blocks using the hardware central sync unit of FIG. 2.

FIG. 4 is an example process for synchronizing communications between IP blocks in the system of FIG. 1.

FIG. 5 is a flow diagram representing an example sync procedure implemented at the SoC of FIG. 1.

Like reference numbers and designations in the various drawings indicate like elements.

### DETAILED DESCRIPTION

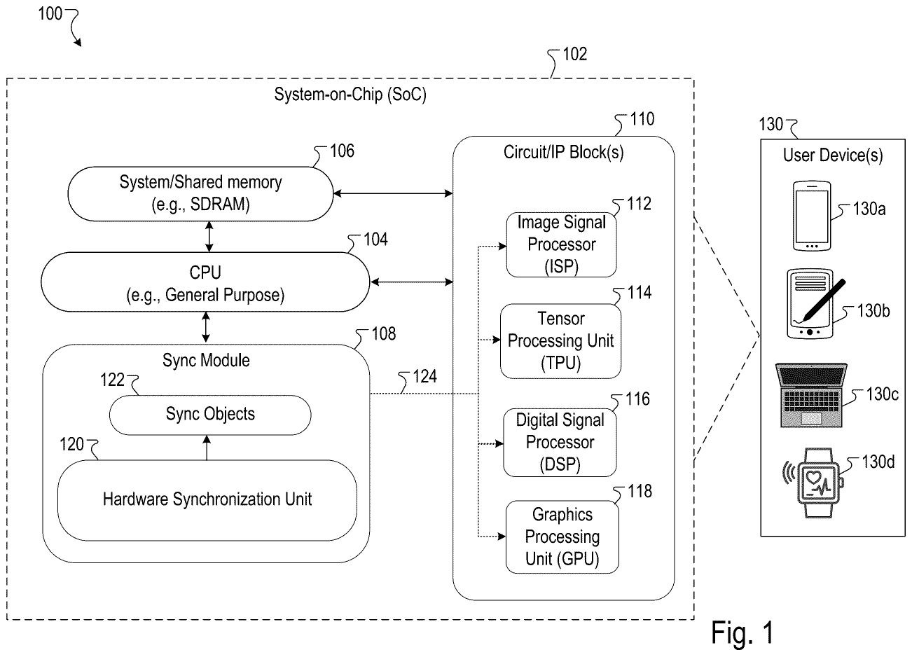

FIG. 1 is a block diagram of an example computing system 100 that includes a system-on-chip 102 (“SoC 102”). In some implementations, system 100 includes multiple SoCs. The SoC 102 includes a central processing unit 104 (“CPU 104”), a shared memory 106 (“memory 106”), a synchronization module 108 (“sync module 108”), and an IP/circuit block 110.

The CPU 104 can be a general purpose CPU (e.g., a single or multi-core CPU). The CPU 104 generates one or more indicators, such as an app-launch indicator or a function call that is triggered in response to executing or launching an application at a user device. For example, the application can be a camera application that uses an imaging sensor to generate image data or a gaming application that requires substantial memory and graphics processing resources to render graphical content of the game. The CPU 104 also generates one or more application values, such as pixel values or frame rate. The application values may be associated with a function call, may be descriptive of an event that occurs during execution of the application, or both.

The memory 106 is a system memory, shared memory, or both. In the example of FIG. 1, memory 106 is depicted external to circuit block 110. However, memory 106 can include portions of memory that are: i) specific to circuit block 110, ii) external to circuit block 110, or iii) both. The memory 106 can be random access memory of the SoC 102, such as a dynamic random access memory (DRAM), a synchronous DRAM (SDRAM), or double data rate (DDR) SDRAM.

In some implementations, aspects of memory 106 are configured as a shared scratchpad memory that supports parallel access of its memory resources by two or more processors of the circuit 110. The memory 106 can also include various other types of memory, such as high bandwidth memory (HBM), narrow memory (e.g., for storing 8-bit values), wide memory (e.g., for storing 16-bit or 32-bit values), etc.

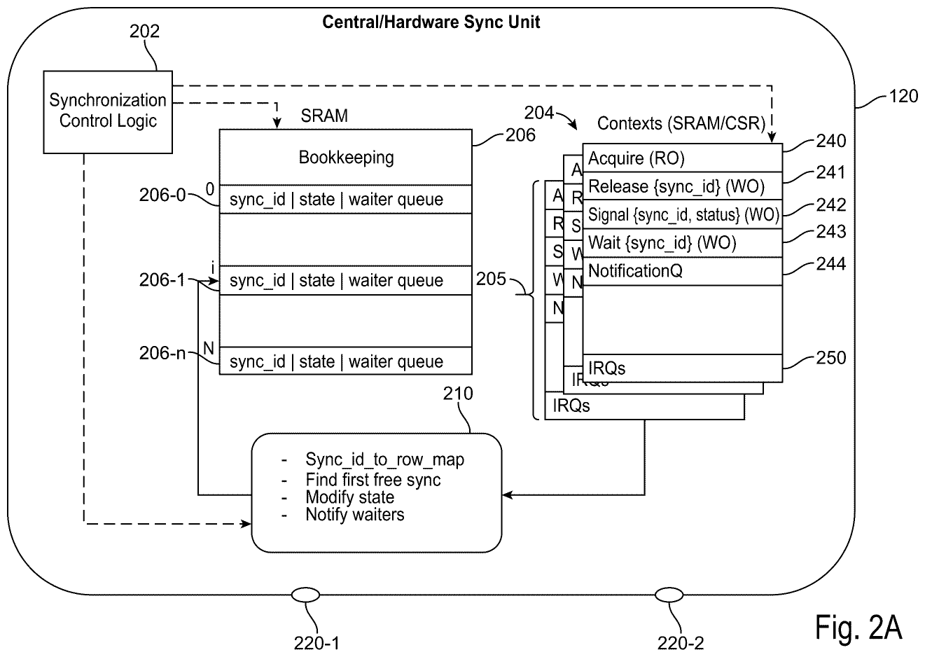

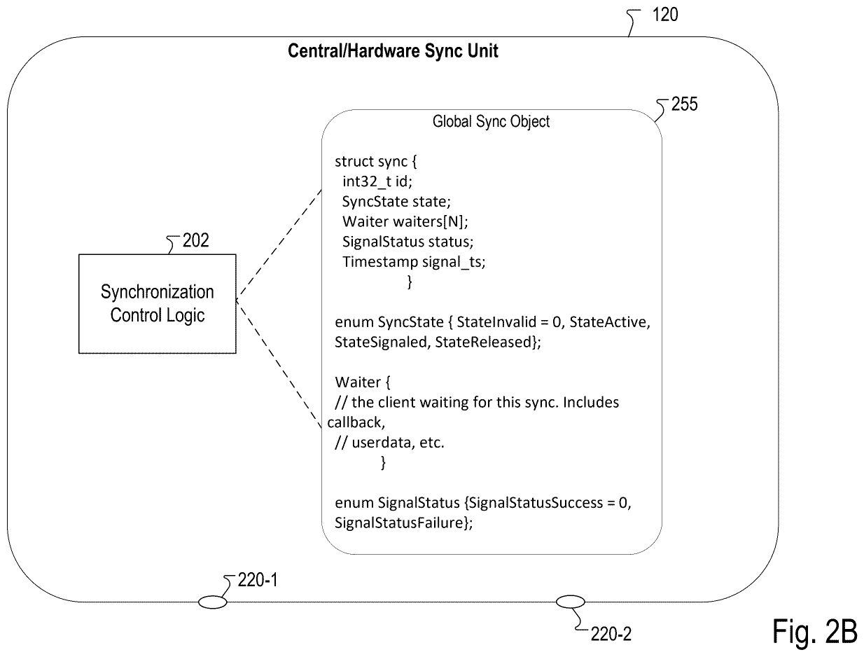

The sync module 108 is implemented in hardware and software. Aspects of the sync module 108 can be also implemented as firmware of the SoC 102 or firmware of a device of the SoC 102, such as the CPU 104. The sync module 108 includes a hardware synchronization unit 120 that is implemented in hardware and software. For example, the hardware synchronization unit 120 includes memory resources (e.g., flip-flops, registers, buffers, etc.) that are implemented in hardware and control logic (e.g., programmed code) that is implemented in software. The hardware synchronization unit 120 is described in more detail below with reference to the example of FIG. 2.

One or more aspects of the sync module 108 can be implemented as a software routine (or module) of the CPU 104 that uses one or more hardware resources of the CPU 104, such as registers, buffers, etc. In some implementations, the CPU 104 is configured as an instruction and vector data processing engine that processes data obtained from a system memory of the SoC 102, such as memory 106.

As described in detail below, the sync module 108 is configured to generate global sync objects 122, as well as control signaling and associated data values, that are used to synchronize events and communications between devices of the system 100. The devices include processors, processor cores, or special-purpose processing devices, such as individual IP devices of the circuit block 110.

The circuit block 110 can include an image signal processor (ISP) 112, a tensor processing unit (TPU) 114, a digital signal processor (DSP) 116, and a graphics processing unit (GPU) 118. The circuit block 110 is referred to alternatively as an IP block 110, where the IP block can include one or more proprietary hardware elements. For example, each of the ISP 112, TPU 114, DSP 116, and GPU 118 can be a respective proprietary IP block (or IP device) of a particular entity or device manufacturer.

The sync module 108 uses operations performed by the hardware synchronization unit 120 to dynamically control and manage one or more synchronization events that are executed at the SoC 102 in support of a heterogeneous compute operation. More specifically, the sync module 108 is configured to generate control signaling 124 and use one or more discrete signal values of the control signaling 124 to arrange and synchronize operations between two or more processing units that are included among the IP block 110, the CPU 104, or both. In some implementations, each processor (e.g., ISP, DSP, TPU, GPU, or CPU) of the SoC 102 includes multiple cores and the sync module 108 can generate control signaling 124 to synchronize or otherwise manage events at each core of the processors.

In the example of FIG. 1, system 100 and the SoC 102 is an integrated circuit of an example user/client device, consumer electronic device, or mobile device, where each of these devices can include items such as a smartphone 130a, tablet 130b, laptop 130c, smartwatch or wearable device 130d. The devices may also include other items such as an eNotebook, Netbook, smart speaker, or mobile computer. In some implementations, the system 100 and the SoC 102 is an integrated circuit of a desktop computer, network server, or related cloud-based asset.

FIG. 2A shows an example hardware central synchronization unit (“CSU”) 120 that is used to universally synchronize communications between devices of the SoC 102, such as IP devices of circuit block 110. The hardware synchronization unit 120 includes various resources for implementing universal IP synchronization, including one-to-many and many-to-many synchronization between IP devices of the SoC 102.

The resources of the hardware synchronization unit include control logic 202 and memory for generating, tracking, and managing sync objects or data values corresponding to synchronization events executed at the SoC. More specifically, the hardware synchronization unit 120 includes a first memory 204 and a second memory 206. In some implementations, first memory 204 and second memory 206 are the same memory. In some other implementations, first memory 204 and second memory 206 are different memory circuits/units.

The first memory 204 can include a combination of SRAM circuits and CSR circuits, whereas the second memory 206 can include one or more SRAM circuits. The first memory 204 can include one or more CSR groupings 205 (“register groupings 205”), where each register grouping 205 includes a group of CSRs (or other registers), such as two or more 8-bit registers, 12-bit registers, 16-bit registers, 32-bit registers, etc. In the example of FIG. 2, the first memory 204 includes three register groupings 205; however, the first memory 204 can include more of fewer register groupings 205. In some implementations, the first memory 204 includes a register grouping 205 for each IP device of the SoC 102.

In general, for a given heterogeneous compute, the global state of one or more sync objects (or syncs) are well-defined in a structured memory of SRAM and register resources of the hardware synchronization unit 120. The hardware synchronization unit 120 uses its control logic 202 and memory resources 204, 206 to maintain the global synchronization states of multiple devices/IP devices of the SoC 102. In some implementations, the hardware synchronization unit 120 is a discrete processor of the SoC 102, the sync module 108, or both.

For example, the control logic 202 can be a processor or logic unit that causes the hardware synchronization unit 120 to maintain multiple global sync objects' states (e.g., as context states). In the example of FIG. 2B, the control logic 202 can generate and/or define a sync object or global sync object using the example code 255. The control logic 202 can also generate control signaling to broadcast synchronization information to consumer IP devices when a producer IP device satisfies a sync.

In some examples, a sync may be “satisfied” when the IP device associates a sync object with a particular condition. The IP device can make the association with the particular condition based on analysis or determinations made by a driver software of the IP device. The particular condition may be that IP device A (producer) has finished writing data to a buffer of the system. When, or immediately after, that condition occurs, the sync will be signaled by the corresponding IP device A, which in turn satisfies the sync (e.g., signals the sync).

The synchronization unit 120 is configured to maintain a global state for synchronization activity that spans two or more devices of the SoC 102, such as processors, processor cores, processing units, IP devices, or circuits block 110. The hardware synchronization unit 120 is configured to maintain these global synchronization states without requiring or implementing software layer translations for synchronization signals that are generated and passed between the devices.

The hardware synchronization unit 120 determines context states with reference to a global sync object that it uses to control and manage synchronization events at the SoC 102. For example, the control logic 202 can detect and/or analyze outgoing and incoming synchronization signals (or values) and determine context states based on those synchronization signals. At least one context state corresponds to a respective device on the SoC 102. In some implementations, each of the context states correspond to a respective IP device among multiple IP devices on the SoC 102.

For example, the hardware synchronization unit 120 can determine a respective context state for the ISP 112, a respective context state for the TPU 114, a respective context state for the DSP 116, and a respective context state for the GPU 118. In some implementations, the hardware synchronization unit 120 uses contexts and context states to allow concurrency of access between multiple IP devices and to maintain synchronization integrity with respect to those concurrent accesses. For each client or IP device, a context provides an abstraction where each IP device works within in its own synchronization context. In general, each context can be tied to a set of registers that is required to perform operations on a particular sync object or set of sync objects.

In some implementations, each context state is represented by a combination of values stored across the first memory 204 and the second memory 206. For a given synchronization event, an IP device can first acquire a context allocation from the hardware synchronization unit 120 to create one or more sync objects and then wait on that sync object or signal that sync object to another IP device. In some implementations, a client IP driver of the IP device is used to acquire the context allocation.

Each context can have a set of CSRs for implementing an application-programming interface (API) of the hardware synchronization unit 120. For example, a read-only CSR is used to acquire a new sync, whereas a write-only CSR is used for releasing a sync. In some implementations, the control logic 202 determines an assignment and/or allocation of registers such that a context representing synchronization events for an IP device has a corresponding set of CSRs for carrying out operations associated with those synchronization events. For clarity, a context can be include one or more context states, where each context state can indicate attributes or details of a synchronization event, such as a sync signal event or a wait event.

The synchronization unit 120 generates register values that correspond to (or represent) each of the context states. For example, each context state for an IP device can be captured using a set of register values that are stored in the first memory 204 as well as one or more bookkeeping data values of the second memory 206. The hardware synchronization unit 120 includes interface connections 220-1, 220-2, which represent an interface control of the hardware synchronization unit 120. The hardware synchronization unit 120 uses interface connection 220-1 to detect, obtain, or otherwise receive incoming synchronization signals. Relatedly, the hardware synchronization unit 120 uses interface connection 220-2 to transmits, provide, or otherwise pass outgoing synchronization signals.

The control logic 202 can detect and analyze outgoing and incoming synchronization signals and generate corresponding register values based on that analysis. The hardware synchronization unit 120 uses one or more of CSRs of the first memory 204 to store the register data values that indicate (or represent) context states for each of the devices.

In the example of FIG. 2, the hardware synchronization unit 120 includes a register 240 that stores data for an “acquire” parameter, a register 241 that stores data for a “release” parameter, a register 242 that stores data for a “signal” parameter, a register 243 that stores data for a “wait” parameter, a register 244 that stores data for a “NotificationQ” parameter, and a register 250 that stores data for “IRQs.”

An example synchronization operation that uses at least registers 240, 241, 242, and 243 will now be described.

IP device A (“IP_A”) may require a sync object for a given operation. For example, IP_A may need to configure a sync object so that as soon as IP_A is done with a given task on a portion of data, IP device B (“IP_B”) can be notified to do additional work on that portion of data. The required sync object may be triggered by a software driver or other compute logic of IP device A. IP_A initiates a read of register 240 to create, produce, or otherwise obtain the identifier/ID (i.e., sync_ID) of a newly created sync object. In some implementations, the IP_A obtains the ID based on this command “sync my_new_sync=csu_contex0->acquire.”

The system 100 initiates a call to IP_B and passes the new sync in a manner that causes IP_B to wait on a sync state as a dependency while IP_A performs its given task on the data. For example, the system 100 can use the hardware synchronization unit 120 to initiate the call to a driver or other computational logic of IP_B. The hardware synchronization unit 120 can use register 241 to specify register IDs used by IP_A and IP_B during the synchronization context that covers processing this portion data. In some implementations, the system 100 initiates the call to IP_B and passes the new sync based on this command “process_IP_B(work, my_new_sync).”

IP_A uses the hardware synchronization unit 120 to signal the sync by writing its corresponding sync ID to register 242. The interaction between the IP_A and the hardware synchronization unit 120 may be initiated or managed by firmware and/or hardware logic supported by IP_A. In some implementations, system 100 signals the sync and writes the corresponding sync ID based on this command “IP_A_Buffer_done_IRQ_event: csu_contex0->signal=my_new_sync.” The system 100 can initiate processes involving IP_B based on this command “process_IP_B(work, sync).” In general, IP_A and IP_B can be any of the devices of circuit block 110. Additionally, “csu_context” indicates register sets representing a client context in the hardware synchronization unit 120.

The hardware synchronization unit 120 causes IP_B to wait for the dependency regarding IP_A by writing the sync_ID into register 243. In some implementations, the system 100 causes IP_B to wait for the dependency based on the command “csu_context1->wait=sync.” IP_B performs its additional “work” on the portion of data in response to the sync being signaled or after receiving notification about the sync being done. For example, can IP_B perform or execute its additional “work” that depends on this sync based on the command “while ((notified_sync=csu_context1->notificationQ)!=0).” The command may be executed using the IRQ_Handler of the hardware synchronization unit 120.

In some implementations, there can be multiple syncs in flight for the same context. This means, upon CSU IRQ, there could be one or more syncs notified in the notification queue. In other words, for the while loop: “while ((notified_sync=csu_context1->notificationQ)!=0 ),” the owner of csu_context1 will see which one of its pending work items is dependent on the notified sync. In this example the owner is IP_B. If IP_B was waiting for only one sync, then the while loop will just return non-0 once.

In the above and other examples, register 240 is a read-only (RO) register, whereas registers 241, 242, and 243 are write-only registers. In some implementations, data values stored at register 240 are used to “acquire” or create a sync object, a corresponding sync_ID, or both. Data values stored at the register 244 are used to notify an IP device of activity associated with a particular sync object. For example, the TPU 114 may be waiting on 10 different sync objects and the notification register queue is used to notify the TPU 114 that sync objects 1, 3, 5 have been signaled.

The IP devices can use or read data values for IRQs stored at register 250 to obtain notifications from the hardware synchronization unit 120 for a particular synchronization object or synchronization event. For example, the hardware synchronization unit 120 can use an IRQ at register 250 to notify the TPU 114 that an event or action has occurred with regard to a sync or sync object that the TPU 114 may have been waiting for.

More specifically, the hardware synchronization unit 120 is configured to track the signaled syncs for each context and can use IRQs at register 250 to facilitate this tracking. When an IP device or the client of that context reads register 244, each read of that register 244 returns the sync_ID of a corresponding sync that has been signaled. In some implementations, each read of that register by the IP device will also clear the returned sync_ID from the notification queue. When there are no more signaled syncs in the notification queue, any read of register 244 would return a “0”.

The hardware synchronization unit 120 can identify one or more registers of the first memory 204 that are (or have been) allocated or assigned for a given context with reference to a specific IP device. The hardware synchronization unit 120 interacts with that IP device to permit the IP device to acquire register IDs for a given context and to release register IDs for that context. Each IP device communicates information pertaining to a synchronization event to the hardware synchronization unit 120 by writing or updating values to the CSRs of the first memory 204 that are assigned to the IP device for a given synchronization context.

The second memory 206 is used to store a bookkeeping table that includes various “Bookkeeping” values for one or more contexts, context states, or both. The second memory 206 can store the bookkeeping values using a row configuration, where a given row is used or assigned to store one or more values for a context or context state. For example, the values are stored in a “Bookkeeping” table that includes one or more entries 206-0, 206-1, 206-n. In some implementations, the bookkeeping table includes n entries (e.g., rows), 206-n, where n is an integer greater than one.

The bookkeeping table is a global state table that maintains state information for each sync object, including global sync objects that are associated with one or more synchronization events. The bookkeeping table can include an entry (e.g., a row entry) for each sync object that is acquired from, or generated by, the hardware synchronization unit 120. Each entry or row of the bookkeeping table reflects state information for each sync object and indicates how many sync objects are active or available, how many sync object entries are available in the bookkeeping table, and how many sync object entries have already been acquired.

Each of the data values for a sync object entry can correspond to a synchronization event, an IP device, or both. The control logic 202 generates the bookkeeping table based on data values obtained or read from the first memory 204. For example, the control logic 202 can extract, read, or obtain data values for a register grouping 205 and use some (or all) of those data values to generate or populate entries of the bookkeeping table stored at the second memory 206.

In the example of FIG. 2, to maintain state information for a given sync object the bookkeeping table stores data values for “sync_ID,” “state,” and “waiter queue.” In other examples, the bookkeeping table can store more or fewer data values to maintain state information for a given sync object. The “sync_ID” identifies a sync object, the “state” indicates an example state of the sync object, and the “waiter queue” indicates a queue of clients or devices that may be waiting on that sync object. An example “state” of a synchronization object can include: i) free, indicating a sync object is free to be signalled; ii) unsignalled, indicating a sync object is not being (or has not been) signalled; iii) signalled, indicating a sync object is being (or has been) signalled; and iv) error, indicating an error state associated with a sync object.

The sync module 108 can track and maintain a variety of parameters for each synchronization object. For example, the hardware synchronization unit 120 can use the control logic 202 to determine a timestamp (e.g., a global timestamp) that indicates the last state change of a sync object. The control logic 202 can implement a counter that counts or tracks a number of times a sync object (or synchronization event) has been signalled. In some implementations, the counter parameter is particularly relevant for recurring sync events.

As described below, the control logic 202 can configure a recurring sync using combination logic that includes AND, OR, XOR, or other related logical operators. The control logic 202 can also implement a reference count that tracks existing references to a sync. The control logic 202 can use the reference count to trigger changing a state to “free” when a reference count value is set back to “0”.

The hardware synchronization unit 120 is configured to generate compositional sync objects based on a composite or combination of two or more sync objects. More specifically, the control logic 202 can use its logical operators to generate a new (or composite) sync object from two distinct sync objects. For example, if a designer is interested in events that involve signaling both sync object A and B, the control logic 202 can use an ADD operator to generate a new a sync object by ANDing sync object A and sync object B. In another example, if a designer is interested in events that involve signaling any of sync objects A, B, and C, then the control logic 202 can use an OR operator to generate a new a sync object by ORing sync object A, sync object B, and sync object C.

In yet another example, the hardware synchronization unit 120 can generate 10 different sync objects that represent 10 different images or audio samples. The 10 images can represent a single stream with different images sizes. The SoC 102 may want to perform a concurrent operation on all 10 images. So, rather than perform a one-by-one wait operation on each image, the hardware synchronization unit 120 can use the AND operator to combine all 10 sync objects to create a new sync object that represents all 10 images. The hardware synchronization unit 120 can then implement a more streamlined wait event single using the single composite sync object.

In addition to composite sync objects, the hardware synchronization unit 120 can implement certain custom or exotic sync objects. In some implementations, the hardware synchronization unit 120 can implement conditional sync objects, counter-based sync objects, QOS counter-based sync objects, and timer-based sync objects. For example, the control logic 202 can create a conditional sync object that only triggers if/when a certain condition is satisfied, where the condition can be predefined or determined on the fly.

For example, the condition can be based on a certain processing event or a register value of a CSR of the SoC 102 or the sync module 108. The control logic 202 can also create a conditional sync object using the AND, OR, XOR operators. In some examples, the control logic 202 can create timer-based sync objects that trigger after a certain time value or after expiration of a certain time-duration. In some examples, the control logic 202 can create QoS counter-based sync objects that trigger after detecting a certain value in a program counter or upon reading a certain quality of service (QOS) count value in a counter register. For example, the QoS value can be based on a number of bytes or data value for a given service parameter, such as frames per second for a graphics processing operation.

In some implementations, the hardware synchronization unit 120 uses information indicated at a data block 210 to provide data values for updating and maintaining the bookkeeping table. The information at data block 210 can represent data values that are passed from the first memory 204 to the second memory 206. The values at data block 210 can be stored or maintained at the hardware synchronization unit 120. For example, the data block 210 may be a buffer that includes a subset of register values for a context of an IP device. The control logic 202 can read or extract values from that data block 210 and use those values to update, at a corresponding row of the bookkeeping table, state information for a sync object assigned to that IP device (or context).

In some implementations, the sync module 108 and/or hardware synchronization unit 120 is a floating role migrating compute element of the SoC 102. Aspects of the hardware mechanism that incorporate floating role elements will migrate between different processing devices that may be included among an active set of IP devices on the SoC 102. The hardware synchronization unit 120 can include logic (e.g., software/firmware) and control elements that enable sync roles to migrate or float among the IP devices of the circuit block 110. For example, to enable floating role sync functions at a given IP device, the hardware synchronization unit 120 can implement a respective portion of its control logic and one or more interface connections at that IP device.

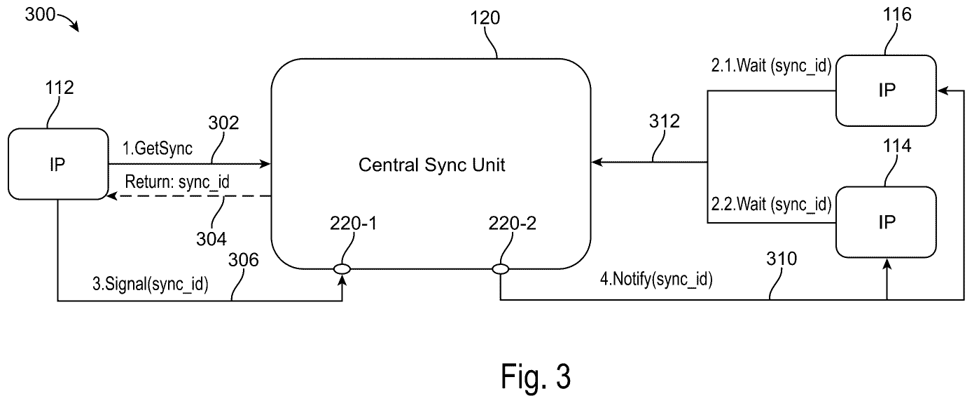

FIG. 3 is a block diagram 300 of example communications involving the hardware synchronization unit 120 and IP blocks of SoC 102. In general, the example of FIG. 3 depicts a high-level context of a central sync unit (“CSU”) represented by the hardware synchronization unit 120. In this example, the CSU can be seen as a synchronization router among compute IPs, enabling many-to-many synchronization in the most efficient and uniform manner.

As described above, the sync module 108 uses operations performed by the central hardware synchronization unit 120 to dynamically control and manage synchronization events at the SoC 102. The synchronization events are controlled and executed in support of a heterogeneous compute. More specifically, the hardware synchronization unit 120 can generate discrete signal values of the control signaling 124 to arrange and synchronize operations between, for example: i) IP devices of the IP block 110 and/or ii) the CPU 104 and circuit block 110.

In some implementations, the synchronization unit 120 generates control signaling 124 to synchronize or otherwise manage events at each IP device. For example, the control signaling 124 can include at least one control value for synchronizing events at the ISP 112, at least one control value for synchronizing events at the TPU 114, at least one control value for synchronizing events at the DSP 116, and at least one control value for synchronizing events at the GPU 118. Each of these control values can represent a global sync object, can be used to pass a global sync object to an IP device, or both.

The hardware synchronization unit 120 (or sync module 108) uses its control signalling 124 to synchronize events among multiple IP devices in a manner that is universal to each IP device of the SoC 102. For example, the hardware synchronization unit 120 can generate a global sync object that is included among the control signaling 124 used to control and manage synchronization events of a heterogeneous compute executed at the SoC 102.

The hardware synchronization unit 120 can generate the global sync object in response to receiving a request from an IP device of the SoC 102. For example, the global sync object may be generated based on a request 302 from an IP device or an application (e.g., a camera) that generates data for processing by multiple IP devices of the SoC. Each IP device can be a processor (or processor core) of an IP block 110 on the SoC 102. In the example of FIG. 3, the hardware synchronization unit 120 can generate a global sync object based on a “GetSync” request 302 from ISP 112.

The global sync object can be returned using one or more signal values of control signaling 124. In the example implementation of FIG. 3, the global sync object is returned or passed to an example IP device (e.g., ISP 112) as a “sync_ID” signal 304. This sync_ID signal 304 represents a global sync ID for tracking a subset of synchronization events at the SoC 102. For example, the sync_ID signal 304 can be used by the hardware synchronization unit 120 as a basis for tracking synchronization events associated with a particular heterogeneous compute.

In some implementations, the control signaling 124 is used to trigger a first IP device to generate a global sync object that the first IP device then passes to a second, different IP device to synchronize events between the first and second IP devices. The first IP device can use the control signaling 124 to signal a compute operation or an event (e.g., a “wait” event) to more than one IP device. In the example of FIG. 3 the ISP 112 can generate one or more secondary global sync objects based on the control signaling 124.

The secondary global sync objects can be represented by a “sync_ID” signal 306. This “sync_ID” signal 306 can indicate one or more synchronization events (or activity) of a heterogeneous compute. The synchronization events can include a “signal event” and a “wait event.” The hardware synchronization unit 120 can detect and monitor these “sync_ID” signals via its control interfaces 220-1, 220-2. The hardware synchronization unit 120 can generate and transmit control signals via control interface 220-2 to notify example IP devices such as TPU 114 and DSP 116. The control signaling may be associated with a “wait event.”

The hardware synchronization unit 120 can detect one or more secondary global sync objects that are generated based on the control signaling 124 that initiates execution of synchronization events at the SoC 102. The secondary global sync objects can be wait event signals or notify signals corresponding to a universal sync ID that is propagated to a respective IP device of the SoC 102. For example, the hardware synchronization unit 120 can pass a notify signal 310 that indicates a sync_ID for a global sync object. Each of the IP devices 114, 116 can generate respective wait signals 312 that are passed to the hardware synchronization unit 120.

In some implementations, the wait signals 312 are secondary global sync objects that indicate to the hardware synchronization unit 120 that the TPU 114 and DSP 116 have access to a sync handle/object associated with the sync_ID. The secondary sync objects can indicate to the hardware synchronization unit 120 that the IP devices are waiting on a synchronization event connected to the primary sync object or sync_ID. In some examples, the GPU 118 may be consuming an image that was generated by the ISP 112, and the notify signal 310 causes the TPU 114 and DSP 116 to wait for an event from the ISP 112 before accessing a buffer that stores the image.

The secondary sync objects may be passed between at least two IP devices to execute one or more synchronization events for a heterogeneous compute. In some implementations, secondary global sync objects are used to execute respective synchronization events for distinct data processing operations, such as inference operations and graphics operations, that are performed concurrently to process event data associated with an application executed at the user device 130.

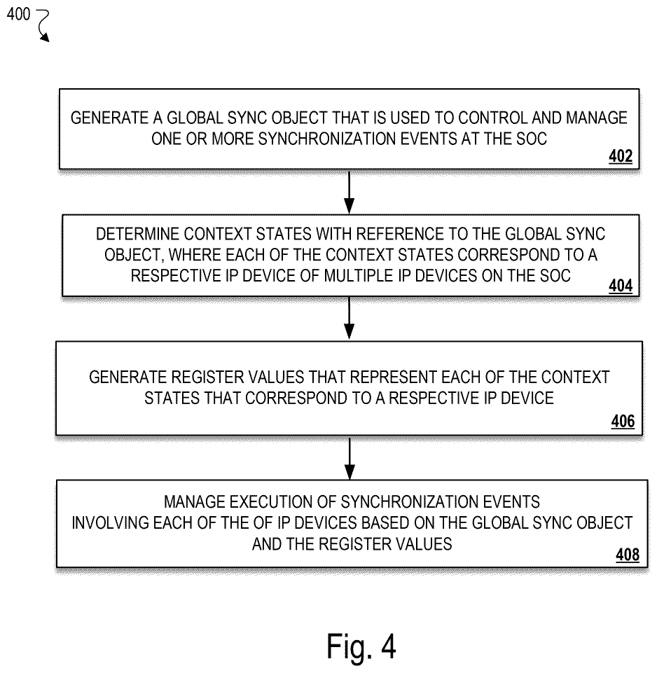

FIG. 4 is an example process 400 for synchronizing communications between IP blocks in the system of FIG. 1. Process 400 can be implemented or executed using system 100 and the hardware sync unit 120 described above. Hence, descriptions of process 400 may reference the above-mentioned computing resources of system 100. In some examples, the steps or actions of process 400 are enabled by programmed software instructions, firmware instructions, or both. Each type of instruction may be stored in a non-transitory machine-readable storage device and is executable by one or more of the processors or other resources described in this document.

In some implementations, the steps of process 400 are performed at a hardware integrated circuit to generate a machine-learning (ML) output, including an output for a neural network layer of a neural network that implements one or more ML models. For example, the output can be a portion of a computation for a ML task or inference workload to generate an image processing, speech processing, or image recognition output. As indicated above, a portion of the integrated circuit can include a special-purpose neural network processor or hardware ML accelerator configured to accelerate computations for generating different types of data processing outputs.

Referring again to process 400, the hardware synchronization unit 120 generates a global sync object 122 that is used to control and manage one or more synchronization events at the SoC (402). For example, the hardware synchronization unit 120 can receive a global sync request from a first IP device of the circuit block 110 or an application being executed at the user device 130. The hardware synchronization unit 120 can then generate the global sync object based on the global sync request from the first IP device. The global sync request can be represented by the “GetSync” request 302.

In some implementations, a sync or synchronization object is coupled to an interrupt at creation time to realize certain efficiencies. The hardware synchronization unit 120 can use the interrupts to configure one or more recurring syncs. More specifically, the control logic 202 can configure a recurring sync using combination logic that includes AND, OR, XOR, or other related logical operators. For example, when a synchronization object is created or acquired, to configure a recurring sync, the control logic 202 can couple that sync object to a logical AND/OR combination of interrupts.

The hardware synchronization unit 120 can use the logical combination of interrupts to streamline synchronization operations, leading to improved efficiency. For example, rather than create another sync object for each occurrence of an interrupt, the control logic 202 can generate a recurring sync such that every time a target interrupt occurs, the sync is signaled automatically. For example, the sync can be signaled automatically each time system 100 detects or determines an occurrence of a target interrupt. In this and other examples, an IP device that is a “waiter client” can differentiate new sync signals (e.g., from recurring sync signals) through the timestamp and/or signal counter parameters, which are described above with reference to FIG. 2.

The synchronization unit 120 determines multiple context states with reference to the global sync object (404). For an example heterogeneous compute (e.g., image or audio processing), the hardware synchronization unit 120 will control and/or manage multiple synchronization events. The hardware synchronization unit 120 is configured to analyze the outgoing and incoming synchronization signals (or values) for at least a portion of the synchronization events. The hardware synchronization unit 120 can determine multiple context states for one or more IP devices based on that signal analysis.

The hardware synchronization unit 120 can associate each of the multiple context states with: i) a respective IP device of circuit block 110 and ii) synchronization activity corresponding to that respective IP device. The hardware synchronization unit 120 determines these associations using the global sync object, one or more secondary global sync objects, or both. More specifically, the hardware synchronization unit 120 can determine these associations based on analysis of a global sync object, a secondary global sync object, signal communications between IP devices, or a combination of these.

The synchronization unit 120 generates register values that represent each of the context states (406). In the example heterogeneous compute, for each of the multiple context states, the hardware synchronization unit 120 can also generate a corresponding set of register values based on analysis outgoing and incoming synchronization signals. The hardware synchronization unit 120 can also use one or more register values to determine associations between context states and IP devices. In some implementations, the hardware synchronization unit 120 performs two or more operations in parallel to determine context states, determine associations between context states and IP devices, and generate register values.

The synchronization unit 120 manages execution of synchronization events based on the global sync object and the register values (408). The synchronization events involve each of the of IP devices on the SoC 102 and are executed concurrent with a heterogeneous compute operation that is performed at the SoC 102 using the IP devices of circuit block 110.

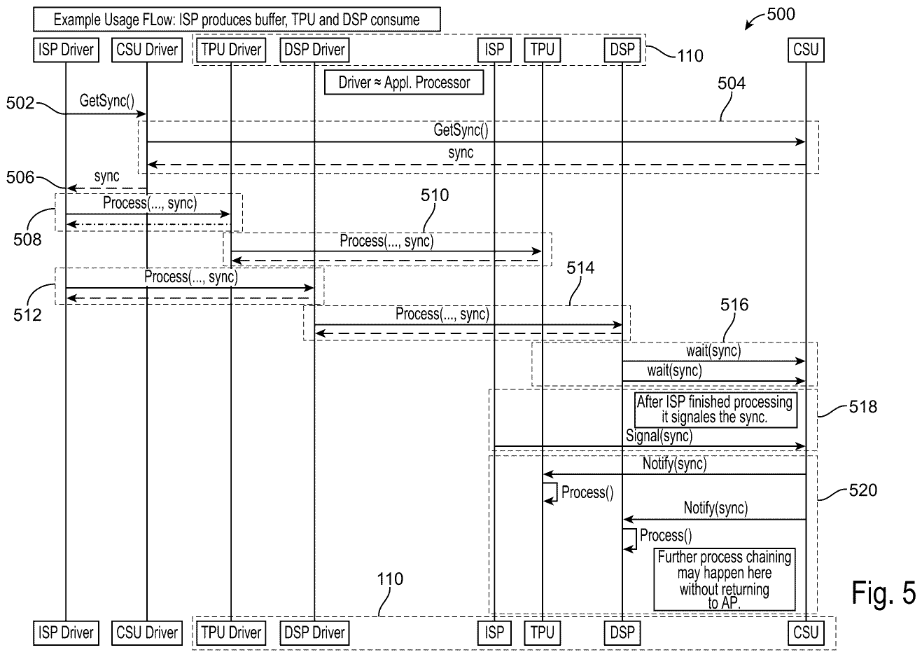

FIG. 5 is a flow diagram representing an example sync procedure 500 implemented at the SoC of FIG. 1. Much like process 400, sync procedure 500 can be implemented or executed using system 100 and the hardware sync unit 120 described above. The steps or actions of procedure 500 are performed using programmed software instructions, firmware instructions, or both. One or more of the instructions may be stored in a non-transitory machine-readable storage device and are executable by one or more of the processors or other resources described in this document.

As indicated above, to process the data, the SoC 102 can initiate a heterogeneous compute operation where some (or all) of the multiple IP devices, e.g., ISP 112, TPU 114, DSP 116, and GPU 118, are responsible for a specific compute of the heterogeneous operation. For example, the data can be image data and the heterogeneous compute can include: i) an inference operation to perform facial recognition on the image data and ii) a scaling operation to perform post-processing on the image data. In general, because the heterogeneous compute can involve multiple IP devices on the SoC 102 and the system 100 will require synchronization of certain compute steps amongst the IP devices. In this manner, the hardware synchronization unit 120 is configured to provide universal/shared synchronization semantics to convey meaning to synchronization objects that are used to streamline sync operations among a variety of IP devices on the SoC 102.

Referring again to sync procedure 500, an example operation that uses procedure 500 can involve a camera IP device that requires a synchronization object to represent or indicate that an image has been generated by an image sensor of a user device 130 or a decoder IP device may require a synchronization object to represent or indicate that data associated with an image has been decoded. The hardware synchronization unit 120 can process a respective request from each of these IP devices and permit these devices to acquire a synchronization object and allocate resources the define synchronization contexts relating to these requests.

Using the example involving the camera IP device, the image sensor may be controlled by the ISP 112 of the user device 130. The ISP 112 uses its ISP driver to pass a “GetSync” signal (502) to a driver (or driver logic) of the sync module 108. The sync module's driver can be an example application processor (AP). In some implementations, this driver logic of the sync module 108 corresponds to, or is included with, the control logic 202 of the hardware synchronization unit 120.

The hardware synchronization unit 120 uses its driver logic to generate control signaling 124 based on the “GetSync” signal, where the control signaling can include a first sync control signal (“sync”) (504). The “sync” control signal of the control signaling 124 can initiate execution of one or more synchronization events at the SoC 102. The driver of the hardware synchronization unit 120 passes a global sync object to the ISP 112 based on the “sync” control signal (506). In some implementations, the passing of this global sync object represents the creation (or acquisition) of a synchronization ID (“sync ID”).

The ISP 112 uses the global sync object to signal a process operation (508) to the TPU 114. For example, the ISP 112 can signal the TPU 114 to request that the TPU 114 perform an image processing operation on the image, such as an inference operation to generate a facial recognition output. In the example of FIG. 5, the signaling for the process operation is performed between respective drivers of the ISP 112 and the TPU 114. In some implementations, the drivers referenced in the example of FIG. 5 are run on an example AP of the corresponding IP device. The TPU 114 can generate an internal call operation (510), e.g., to call its own stack, which eventually goes to the TPU firmware on the TPU hardware.

Similarly, the ISP 112 uses the global sync object to signal a process operation (512) to the DSP 116. For example, the ISP 112 can signal the DSP 116 to request that the DSP 116 perform an image processing operation on the image, such as a scaling operation to perform post-processing on the image data. In the example of FIG. 5, the signaling for this particular process operation is performed between respective drivers of the ISP 112 and the DSP 116. The DSP 116 can generate an internal call operation (514), e.g., to call its own stack, which eventually goes to the DSP firmware on the DSP hardware.

Before initiating their respective operations on the image, each of the TPU 114 and DSP 116 can pass signal notifications to the hardware synchronization unit 120 to signal “wait(sync)” with reference to the global sync object (516). For example, each of the TPU 114 and DSP 116 can perform a respective “wait event” to ensure it does not proceed to operate on the image before the hardware synchronization unit 120 informs the TPU 114 or DSP 116 that it can begin its respective operations on the image. In some implementations, each of the TPU 114 and DSP 116 executes its wait event in parallel with each other and in parallel with other synchronization signalling operations that are performed by the ISP 112.

For example, the ISP 112 can pre-emptively signal the TPU 114 and the DSP 116 while the ISP 112 is still performing operations on the image. When the ISP 112 has completed its work on the image, the ISP 112 can signal the sync, via a “signal(sync)” operation (518), and pass the synchronization object to the hardware synchronization unit 120. The hardware synchronization unit 120 can generate and transmit control signals to notify the TPU 114 and DSP 116 to begin respective processing operations on the image (520).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method performed at a system-on-chip (“SoC”) of a user device using a hardware sync unit of the SoC, the method comprising:
generating, by the hardware sync unit, a global sync object that is used to control and manage one or more synchronization events at the SoC;
determining, by the hardware sync unit, a plurality of context states with reference to the global sync object, each of the plurality of context states corresponding to a respective IP device of a plurality of IP devices on the SoC;
generating, at the hardware sync unit, a plurality of register values that represent each of the plurality of context states corresponding to each respective IP device; and
managing, by the hardware sync unit, an execution of synchronization events involving each of the plurality of IP devices based on the global sync object and the plurality of register values.

2. The method of claim 1, wherein generating the global sync object comprises:
receiving, by the hardware sync unit, a global sync request from a first IP device; and
generating, by the hardware sync unit, the global sync object based on the global sync request from a first IP device.

3. The method of claim 2, wherein generating the global sync object comprises:
generating, by the hardware sync unit, control signaling that initiates execution of the synchronization events at the SoC;
wherein the control signaling comprises a first sync control signal that passes the global sync object to the first IP device.

4. The method of claim 1, further comprising:
detecting, by the hardware sync unit, a plurality of secondary global sync objects that are generated based on the control signaling that initiates execution of the synchronization events at the SoC;
wherein each of the plurality of secondary global sync objects corresponds to a universal sync ID that is propagated to a respective IP device of the plurality of IP devices.

5. The method of claim 4, wherein one or more of the plurality of secondary global sync objects are:
passed between at least two of the plurality of IP devices to execute one or more of the synchronization events; and
used to execute respective synchronization events for distinct data processing operations that are performed concurrently to process event data associated with an application executed at the user device.

6. The method of claim 1, further comprising:
synchronizing, using the hardware sync unit, a subset of communications at the SoC based on the global sync object and each of the plurality of register values that represent each of the plurality of context states at the hardware sync unit.

7. The method of claim 1, further comprising:
associating, using the global sync object, each of the plurality of context states with a respective IP device among the plurality of IP devices and synchronization activity corresponding to that IP device.

8. The method of claim 7, wherein, for each of the plurality of IP devices, the synchronization activity comprises:
a first sync event representing a signal event; and
a second, different sync event representing a wait event.

9. The method of claim 1, further comprising:
detecting, at the SoC, a request to process event data associated with an application executed at the user device; and
wherein the synchronization events are executed at the SoC concurrent with data processing operations of each IP device that is used to process the event data.

10. A system comprising:
a hardware sync unit, a processing device, and a non-transitory machine-readable storage device storing instructions that are executable by the processing device to cause performance of operations comprising:
generating, by the hardware sync unit, a global sync object that is used to control and manage one or more synchronization events at the SoC;
determining, by the hardware sync unit, a plurality of context states with reference to the global sync object, each of the plurality of context states corresponding to a respective IP device of a plurality of IP devices on the SoC;
generating, at the hardware sync unit, a plurality of register values that represent each of the plurality of context states corresponding to each respective IP device; and
managing, by the hardware sync unit, an execution of synchronization events involving each of the plurality of IP devices based on the global sync object and the plurality of register values.

11. The system of claim 10, wherein generating the global sync object comprises:
receiving, by the hardware sync unit, a global sync request from a first IP device; and
generating, by the hardware sync unit, the global sync object based on the global sync request from a first IP device.

12. The system of claim 11, wherein generating the global sync object comprises:
generating, by the hardware sync unit, control signaling that initiates execution of the synchronization events at the SoC;
wherein the control signaling comprises a first sync control signal that passes the global sync object to the first IP device.

13. The system of claim 10, wherein the operations further comprise:
detecting, by the hardware sync unit, a plurality of secondary global sync objects that are generated based on the control signaling that initiates execution of the synchronization events at the SoC;
wherein each of the plurality of secondary global sync objects corresponds to a universal sync ID that is propagated to a respective IP device of the plurality of IP devices.

14. The system of claim 13, wherein one or more of the plurality of secondary global sync objects are:
passed between at least two of the plurality of IP devices to execute one or more of the synchronization events; and
used to execute respective synchronization events for distinct data processing operations that are performed concurrently to process event data associated with an application executed at the user device.

15. The system of claim 10, wherein the operations further comprise:
synchronizing, using the hardware sync unit, a subset of communications at the SoC based on the global sync object and each of the plurality of register values that represent each of the plurality of context states at the hardware sync unit.

16. The system of claim 10, wherein the operations further comprise:
associating, using the global sync object, each of the plurality of context states with a respective IP device among the plurality of IP devices and synchronization activity corresponding to that IP device.

17. The system of claim 16, wherein, for each of the plurality of IP devices, the synchronization activity comprises:
a first sync event representing a signal event; and
a second, different sync event representing a wait event.

18. The system of claim 10, wherein the operations further comprise:
detecting, at the SoC, a request to process event data associated with an application executed at the user device; and
wherein the synchronization events are executed at the SoC concurrent with data processing operations of each IP device that is used to process the event data.

19. A non-transitory machine-readable storage device storing instructions that are executable by a processing device to cause performance of operations involving a hardware sync unit, the operations comprising:
generating, by the hardware sync unit, a global sync object that is used to control and manage one or more synchronization events at the SoC;
determining, by the hardware sync unit, a plurality of context states with reference to the global sync object, each of the plurality of context states corresponding to a respective IP device of a plurality of IP devices on the SoC;
generating, at the hardware sync unit, a plurality of register values that represent each of the plurality of context states corresponding to each respective IP device; and
managing, by the hardware sync unit, an execution of synchronization events involving each of the plurality of IP devices based on the global sync object and the plurality of register values.

20. The non-transitory machine-readable storage device of claim 19, wherein generating the global sync object comprises:
receiving, by the hardware sync unit, a global sync request from a first IP device; and
generating, by the hardware sync unit, the global sync object based on the global sync request from a first IP device.
